(19) United States
(12) Patent Application Publication
(10) Pub. No.: US 2015/0055318 A1
(43) Pub. Date: Feb. 26, 2015

(54) STROBE LIGHT DEVICE

(71) Applicants: STANLEY ELECTRIC CO., LTD., Meguro-ku, Tokyo (JP); ASAHI KASEI CHEMICALS CORPORATION, Chiyoda-ku, Tokyo (JP)

(72) Inventors: Yuji Tamaki, Tokyo (JP); Fumiaki Takashima, Tokyo (JP); Shunichi Hashimoto, Tokyo (JP); Nobuhiro Kobayashi, Tokyo (JP)

(73) Assignees: ASAHI KASEI CHEMICALS CORPORATION, Chiyoda-ku, Tokyo (JP); STANLEY ELECTRIC CO., LTD., Meguro-ku, Tokyo (JP)

(21) Appl. No.: 14/390,367

(22) PCT Filed: Mar. 19, 2013
(86) PCT No.: PCT/JP2013/057833

§ 371 Date: Oct. 2, 2014

(30) Foreign Application Priority Data
Apr. 3, 2012 (JP) 2012-084872

(51) Int. Cl. F21V 9/04; F21V 7/04; G03B 15/05; F21V 5/04

(52) U.S. Cl. CPC F21V 9/04; F21V 5/04; F21V 7/04; G03B 15/05; F21Y 2101/02
USPC 362/16

(57) ABSTRACT

While maintaining weathering resistance, occurrence of whitening in the lens of the strobe light device is prevented and a color temperature of the emitted light required by the strobe light device is adjusted to fall into a preferable range. A lens of the strobe light device contains a base material and an ultraviolet absorber, and the base material is methacrylic resin. The ultraviolet absorber is contained at the rate of between or equal to 0.01 and 0.3 parts by mass, to 100 parts by mass of the base material. The lens may further contain a visible light absorber as a color temperature adjuster, and the visible light absorber preferably has a maximum absorption wavelength of between or equal to 380 nm and 495 nm.

### TECHNICAL FIELD

The present invention relates to a strobe light device, and in particular, it relates to a strobe light device having a lens that is resistant to occurrence of whitening.

### BACKGROUND ART

As described in the patent document 1, for instance, the strobe light device has a configuration that outputs light from an illuminator such as a xenon lamp, via a lens disposed at the forward aperture, expanding the light outwardly in desired orientations.

In recent years, in tandem with penetration of digital still camera, there is increasing usage such as continuous shooting while successively emitting the strobe light at short intervals. Therefore, the patent document 2 discloses a structure to circulate the air within the strobe light device for cooling, so as to prevent the lens from deformed and fused, caused by heating of the light source.

In addition, the patent document 3 suggests to form fine unevenness on the surface of a transparent resin member (the member for preventing strobe light trigger) that is placed near the light source of the strobe light device, so as to prevent occurrence of white turbidity in the transparent resin member, with the increase of the number of strobe light emissions.

The patent document 4 discloses that in order to prevent tarnishing of the optical lens made of transparent resin in the strobe light device with the light source such as the xenon lamp, an ultraviolet absorber is added to the resin.

The patent document 5 discloses that the ultraviolet absorber is added to alight diffusion plate of the strobe light device, thereby adjusting a quality of the light being emitted.

### PRIOR ART DOCUMENT

### Patent Document

### Patent Document 1

Japanese Unexamined Patent Application Publication No. 2009-204980

### Patent Document 2

Japanese Unexamined Patent Application Publication No. 2010-197583

### Patent Document 3

Japanese Unexamined Patent Application Publication No. 8-69034

### Patent Document 4

Japanese Unexamined Patent Application Publication No. 2011-90341 (paragraphs 0027 and 0028, in particular)

### Patent Document 5

Japanese Unexamined Patent Application Publication No. 6-250269 (paragraph 0018, in particular)

### DISCLOSURE OF THE INVENTION

### Problem to be Solved by the Invention

A relatively high concentration of ultraviolet absorber is added to a resin lens (lens made of resin) of the strobe light device that is used currently. This is because the absorber absorbs ultraviolet light contained in the outside light, so as to prevent deterioration of the lens (to enhance weathering resistance), prevent deterioration such as tarnishing due to light illuminated from the light source (patent document 4), adjust the quality of the light outputted from the lens (patent document 5), and the like. In addition, since the ultraviolet absorber also absorbs a short wavelength range of visible light, this feature is utilized to adjust the range of the color temperature of the light being illuminated, to the range being required as the strobe light, by controlling the amount of the ultraviolet absorber. However, even though a relatively high concentration of ultraviolet absorber is added to the lens, if a test is conduced to emit light from the strobe light device repeatedly, for instance, approximately 5,000 times of emission may cause whitening on the surface of the resin lens, looking like partially melted.

As a countermeasure against this problem, as described in the patent document 4, it is conceivable to increase the additive amount the ultraviolet absorber more so as to further filter out UV rays. However, this method has not been successful yet in being fully effective.

In view of the aforementioned problem in the conventional technique, an object of the present invention is to provide a technique that prevents occurrence of whitening in the lens of the strobe light device, while maintaining weathering resistance, and also adjusts the color temperature of the emitted light required by the strobe light device, to fall into a preferable range.

### Means to Solve the Problem

In order to achieve the object as described above, the strobe light device of the present invention has an illuminator, and a lens allowing light emitted from the illuminator to pass through and illuminate the light outwardly. The lens contains a base material and an ultraviolet absorber, and the base material may be methacrylic resin. The ultraviolet absorber may be contained at the rate of between or equal to 0.01 and 0.3 parts by mass, to 100 parts by mass of the base material.

Preferably, the lens may further contain a visible light absorber as a color temperature adjuster. For this case, the visible light absorber preferably has a maximum absorption wavelength of between or equal to 380 nm and 495 nm.

### Effect of the Invention

According to the present invention, it is possible to obtain a strobe light device that is able to effectively prevent occurrence of whitening, and adjust the color temperature to fall into the range required by the strobe light device, even though UV rays emitted from the strobe light source are received cumulatively for a long time.

### BRIEF DESCRIPTION OF DRAWINGS

FIG. 1(a) and FIG. 1(b) illustrate the structure of the strobe light device of the present embodiment; FIG. 1(a) shows the configuration that uses a xenon lamp as an illuminator, and FIG. 1(b) shows the configuration that uses an LED (light-emitting diode) as the illuminator;

FIG. 2 shows a graph indicating one example of emission spectra of the xenon lamp and the LED used in the strobe light device;

FIG. 3 illustrates the structure of the strobe light device of the present embodiment, showing that a filler is added to the lens; and

FIG. 4 illustrates conditions and evaluation results of the embodiment, in the form of a table.

### MODES FOR CARRYING OUT THE INVENTION

The inventors of the present invention have found, through their extensive research on the problem of the conventional techniques, the ultraviolet absorber contained in the lens of the strobe light device absorbs UV rays in the light emitted from the illuminator (light source) and converts the UV rays into thermal energy, and this causes whitening in the lens. Therefore, the amount of the ultraviolet absorber added to the lens for preventing the lens from tarnishing conventionally, is reduced in the present invention, thereby restraining the amount of the UV rays received by the lens from the illuminator, which is converted into thermal energy. Accordingly, while reserving the operation of the ultraviolet absorber for enhancing the weathering resistance against the outside light, heat caused by the UV rays from the illuminator in the strobe light device is reduced, and this prevents whitening of the lens.

In other words, it is found that the ultraviolet absorber contained in the resin constituting the lens, is configured to be a specific concentration, thereby allowing the aforementioned problem of whitening phenomenon to be solved, without lowering performance such as absorbing performance of particular wavelength, which is originally required.

Hereinafter, the strobe light device of the present embodiment will be explained specifically, with reference to the accompanying drawings.

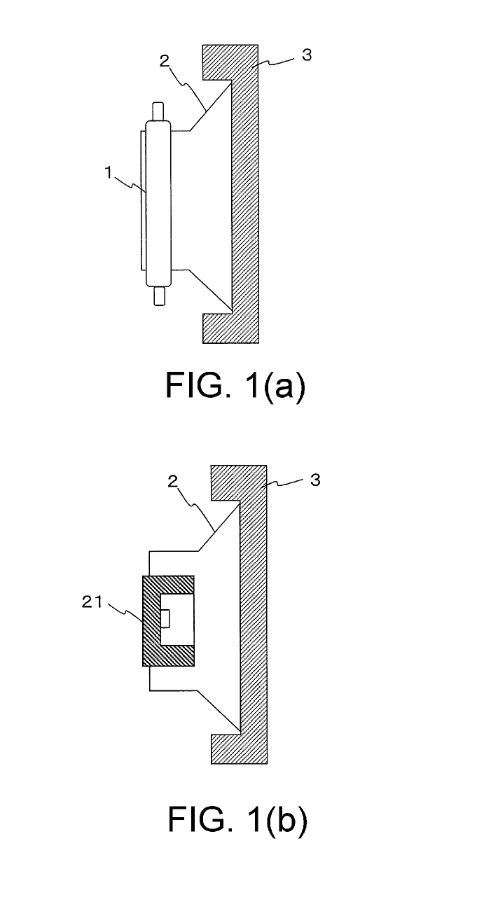

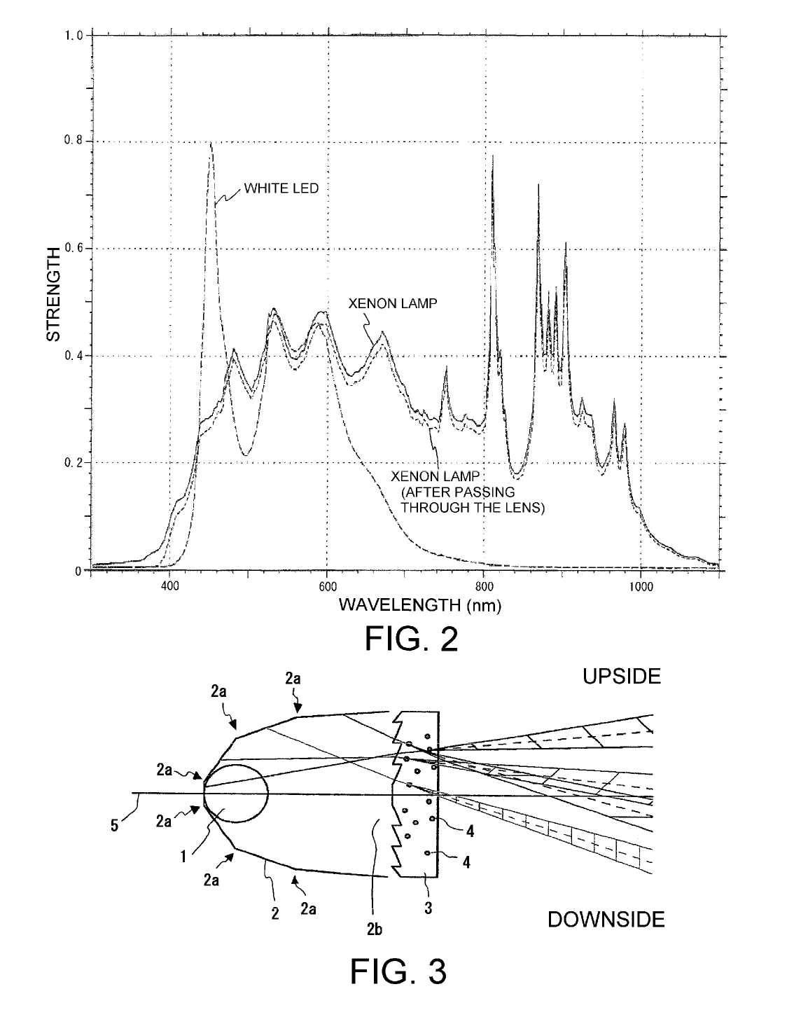

FIG. 1 (a) and FIG. 1 (b) are schematic configurations of a cross sectional structure showing one example of the strobe light device of the present embodiment. This strobe light device is provided with an illuminator 1, a reflector (reflection element) 2, and a lens 3. As the illuminator 1, a xenon lamp, a semiconductor light emitting element (LED), or a light bulb may be employed, for instance. FIG. 1(a) illustrates a configuration example where the xenon lamp is used as the illuminator 1, and FIG. 1(b) illustrates a configuration example where the LED is used. FIG. 2 shows one example of emission spectra of the xenon lamp and the LED. The xenon lamp also emits ultraviolet radiation equal to or less than 380 nm, but by passing through the lens 3, the ultraviolet radiation is reduced.

The reflector 2 takes the shape of covering the circumference of the illuminator 1, and an aperture is formed on the front, so as to output the light toward a photographic subject. The lens 3 is placed in such a manner as covering the aperture of the reflector 2. Though not illustrated in FIG. 1(a) and FIG. 1(b), it is possible to provide a case for supporting the reflector 2 on the outside of the reflector 2, and for this case, the lens 3 is placed on the aperture of the case.

The lens 3 allows the light emitted from the illuminator 1 to pass through and illuminates the light outwardly. The lens 3 contains a base material and an ultraviolet absorber. The base material is assumed as methacrylic resin. It is adjusted so that the rate of the ultraviolet absorber being contained is between or equal to 0.01 and 0.3 parts by mass, to 100 parts by mass of the base material (see Table 1).

In Table 1, each column in the row of “Judgment” indicates the result of overall judgment on the weathering resistance, whitening, and adjustability to the preferable color temperature range of the lens 3 being required by the strobe light device. Here, “X” indicates that the lens is not suitable for the strobe light device, a mark representing a circle (“Circle”) indicates that the lens is suitable for the strobe light device, and a mark representing a double-circle (“Double-Circle”) indicates that the lens is particularly suitable for the strobe light device.

Specifically, the range of the content rate of the ultraviolet absorber “>0 and <0.01 parts by mass” to 100 parts by mass of the base material indicates that the additive amount is too small, failing to reserve the weathering resistance, and thus this lens is not suitable for the strobe light device.

The range of the content rate of the ultraviolet absorber “≧0.01 and <0.05 parts by mass” may allow reservation of the weathering resistance of the lens 3, and no whitening occurs even after emitting the strobe light repeatedly, and thus this lens is suitable. However, since the amount of absorbed short wavelength light in the visible light emitted from the illuminator 1 is small, and the light emitted from the lens 3 may not be adjusted to fall into the color temperature range being suitable for the strobe light device, it is desirable to adjust the color temperature according to some other way. As a means for adjusting the color temperature, the thickness of the lens 3, and gas pressure or tube current of the xenon lamp may be adjusted. In the present invention, in addition to those means, the color temperature may be adjusted by adding a color temperature adjuster described below.

The range of “≧0.05 and ≦0.25 parts by mass” may allow reservation of the weathering resistance of the lens 3, and there is no occurrence of whitening. In addition, the ultraviolet absorber absorbs the short wavelength light out of the visible light emitted from the illuminator 1, thereby adjusting the color temperature to be suitable for the lens of the strobe light device. Therefore, this range is particularly suitable for the lens of the strobe light device.

The range of “>0.25 and ≦0.3 parts by mass” may reserve the weathering resistance of the lens 3. If light is repeatedly emitted from the strobe light device plural times (e.g., 5,000 times), whitening of the lens 3 may occur slightly, but the degree of the whitening is permissible as the strobe light device. As for the color temperature, the short wavelength light out of the visible light emitted from the illuminator 1 is absorbed, and thereby adjusting the color temperature to be suitable for the lens of the strobe light device.

The range of “>0.3 parts by mass” may reserve the weathering resistance of the lens 3. However, if the strobe light device emits light for many times repeatedly, whitening may occur in the lens 3, and this range is not suitable for the lens of the strobe light device.

TABLE 1
ULTRAVIOLET ABSORBER

| | Additive Amount | | | | |
|---|---|---|---|---|---|
| | (Parts by mass) | | | | |
| | 0~0.01 | 0.01~0.05 | 0.05~0.25 | 0.25~0.3 | 0.3~ |
| Judgment | X | ◯ | ⊚ | ◯ | X |

It is preferable that the ultraviolet absorber has the maximum absorption wavelength of between or equal to 300 nm and 400 nm, and more preferably, it is between or equal to 320 nm and 380 nm. It is particularly preferable that the maximum absorption wavelength is 353 nm.

On the other hand, the ultraviolet absorber also absorbs the short wavelength component of the visible light, and thus, it has the property to adjust the color temperature required by the strobe light device, by controlling the concentration of the ultraviolet absorber. Since the ultraviolet absorber is set to be a specific concentration range in order to avoid the aforementioned whitening phenomenon, this may make the color temperature adjustment more difficult. In the present invention, as a means to adjust the “color temperature” required by the strobe light, while avoiding the whitening phenomenon as described above, an additive agent that absorbs a specific wavelength (hereinafter, referred to as “color temperature adjuster”) is added, so as to adjust the color temperature.

In other words, in the present invention, the lens 3 may be configured as further including a visible light absorber as the color temperature adjuster. Preferably, the maximum wavelength absorbed by the visible light absorber is between or equal to 380 nm and 495 nm. Adding the visible light absorber to the lens, as the color temperature adjuster for absorbing the visible light in the wavelength range above, allows the light at a high color temperature (blue-white light) to be adjusted to the light (warm light) at the color temperature required by the strobe light (e.g., 5000K to 6000K), effectively only by a small amount of the color temperature adjuster.

Byway of example, the color temperature adjuster (visible light absorber) is adjusted in such a manner as being contained at the rate of between or equal to 0.0001 parts by mass and 0.0045 parts by mass to 100 parts by mass of the base material (see Table 2). With this settings, when the color temperature of the light emitted from the illuminator 1 is 6000K to 7000K, it is possible to adjust the color temperature to 5000K to 6000K being suitable for the strobe light. If the rate of color temperature adjuster (visible light absorber) is between or equal to 0.0001 parts by mass and 0.004 parts by mass, it is more preferable. In any of the above cases, the thickness of the lens is set to be equal to or less than 3 mm, or more preferably, it is between or equal to 0.5 mm and 3 mm.

If the color temperature adjuster is contained at the rate of between or equal to 0.0005 parts by mass and 0.002 parts by mass to 100 parts by mass of the base material, it is particularly preferable. By adjusting to this range, while controlling the coloring of the lens with the color temperature adjuster itself (yellow), to a level of no problem on appearance, the temperature may be adjusted to the color temperature of 5000K to 6000K being suitable for the strobe light.

TABLE 2
COLOR TEMPERATURE ADJUSTER

| | Parts by mass | | | | | | | | | | |
|---|---|---|---|---|---|---|---|---|---|---|---|
| | 0 | 0.0001 | 0.0005 | 0.001 | 0.0015 | 0.002 | 0.003 | 0.004 | 0.0045 | 0.005 | 0.01 |
| Adjustability to | X | Δ | ◯ | ◯ | ◯ | ◯ | ◯ | Δ | Δ | X | X |
| Preferable | | | | | | | | | | | |
| Color | | | | | | | | | | | |
| Temperature | | | | | | | | | | | |
| Yellow Tinge | ◯ | ◯ | ◯ | ◯ | ◯ | ◯ | Δ | Δ | Δ | X | X |

In Table 2, in each column of the “Adjustability to Preferable Color Temperature”, “Circle” indicates that when the color temperature of the illuminator 1 is 6700K, the lens being 2 mm in thickness to which the color temperature adjuster is added, enables adjustment of the color temperature to be 5000K to 6000K, a mark of triangle shape (“Triangle”) indicates that the color temperature is adjustable depending on the thickness of the lens, even though the color temperature is equal to or lower than 5000K, and “X” indicates failing to adjust the color temperature.

Further in Table 2, in each column of “YELLOW TINGE”, “Circle” indicates that the appearance of the lens is transparent, “Triangle” indicates that the color is slightly yellowish, but if the lens thickness is thin, this color is permissible, and “X” indicates that the color of yellow is visible, and it is unacceptable as the lens of the strobe light device.

It is desirable that the methacrylic resin forming the base material of the lens 3 contains 50 weight % or more of methyl methacrylate.

As shown in FIG. 3, the lens 3 may further contain the filler 4. It is desirable that the refractive index of the filler 4 is between or equal to 1.3 and 2.8, and the average particle size is between or equal to 0.1 μm and 20 μm. It is further desirable that the rate of the contained filler is between or equal to 0.1 parts by mass and 3.0 parts by mass to 100 parts by mass of the base material. Even though the reflector 2 is formed by bending a planar member as shown in FIG. 3, the filler 4 contained in the lens 3 may restrain disorder in orientation characteristics caused by reflection of light beams at the bends 2a of the reflector 2, thereby achieving the strobe light device with a uniform light quantity distribution. This configuration establishes a small-sized strobe light device in which the reflector 2 is bent. It is preferable that the filler 4 is a cross-linked organic particle. This will be explained more in detail later.

Hereinafter, a material of the lens 3 and a method for producing the lens will be explained in detail.

The lens 3 of the strobe light device is a molded body made of methacrylic resin containing 0.01 to 0.3 parts by mass of the ultraviolet absorber, and the lens is placed in opposed to the light source (illuminator 1), allowing the light emitted from the light source and reflected light to pass through. With this configuration, it is possible to make full use of the capabilities of the strobe light device.

The lens 3 takes the shape being required by the lens in the strobe light device. The device may be an illuminating device other than the strobe light device. In this case, the lens has the form suitable for each device, and for instance, it may take the form of a lens for coverage used in an illumination unit of fluorescent light, the form of a lens for coverage used in a unit of signs, the form of lens for coverage used in a unit of markings, or the like.

The lens 3 may take a desired form of lens, so as to improve a light concentration function. The surface of the lens may further be provided with a predetermined pattern to control light orientation and improve the light dispersibility.

Adding the filler 4 (diffusing agent) or the like, to the lens 3, may allow efficient dispersion of entering light, but the filler 4 is not necessarily added.

The methacrylic resin being a material of the lens 3 may preferably be resin consisting principally of methyl methacrylate. Here, “principally” means that the resin contains 50 weight % or more of methyl methacrylate. In particular, copolymerization of methyl methacrylate being from 70 to 100 weight %, and monomers being from 30 to 0 weight % being copolymerizable with the methyl methacrylate, is preferable from a viewpoint of heat resistance,

The weight-average molecular weight of methacrylic resin is preferably 70,000 to 220,000 from a viewpoint of strength, and more preferably it is 80,000 to 200,000. The weight-average molecular weight may be obtained by the gel permeation chromatography (GPC, solvent: tetrahydrofuran).

The monomer being copolymerizable with methyl methacrylate may be, for example, methacrylic acid esters such as butyl methacrylate, ethyl methacrylate, propyl methacrylate, cyclohexyl methacrylate, phenyl methacrylate, and methacrylic acid 2-ethylhexyl; acrylic esters such as methyl acrylate, ethyl acrylate, butyl acrylate, cyclohexyl acrylate, phenyl acrylate, and 2-ethylhexyl acrylate; aromatic vinyl compounds such as methacrylic acid, acrylic acid, styrene, maleic anhydride, 2-hydroxyethyl acrylate, α-methylstyrene, and the like.

In particular, using methacrylic acid, maleic anhydride, phenylmaleimide, or cyclohexylmaleimide as a comonomer may produce an effect of enhancing heat resistance.

Such monomers copolymerizable with methyl methacrylate as described above, may be used by taking one kind or combining at least two kinds thereof.

It is possible to use as the methacrylic resin, MS resin consisting principally of copolymers of methyl methacrylate and styrene, or MS resin being a multi-component copolymer that is obtained by adding to the MS resin, at least one of the aforementioned copolymerizable monomers. When this kind of resin is used as the methacrylic resin, the rate of methyl methacrylate is set to exceed 70 parts by mass, assuming the entire MS resin as 100 parts by mass, thereby achieving favorable weathering resistance and it is more preferable.

A methacrylic resin composition may be used to form a lens for luminescent device, the composition being obtained by adding acrylic rubber of multilayer structure, or the like, to the aforementioned methacrylic resin and providing impact resistance. Moreover, bimodal methacrylic resin with improved rheological characteristics may also be applicable.

As a trend in recent years, a strobe light device or an illumination device is demanded to be brighter and thinner, and under present circumstances, the temperature within the unit is apt to rise. In this kind of light emitting unit, the distance from the illuminator 1 to the lens 3 is short, and spatial volume is small. Therefore, it is effective to use methacrylic resin having high heat resistance.

Such methacrylic resin as described above may be produced by using the aforementioned monomers, according to any publicly known methods, such as suspension polymerization, emulsion polymerization, bulk polymerization, solution polymerization, or the like.

The lens 3 contains the ultraviolet absorber as described above. Following may be taken as example of the ultraviolet absorber; benzotriazole type ultraviolet absorber, benzophenone type ultraviolet absorber, benzoate type ultraviolet absorber, phenyl salicylate type ultraviolet absorber, hindered amine type ultraviolet absorber, and the like.

In particular, from the viewpoint of weathering resistance, it is preferable to use the ultraviolet absorber having a structure of benzotriazole, with the maximum absorption wavelength from 300 nm to 400 nm, more preferably, from 320 nm to 380 nm.

This kind of benzotriazole type ultraviolet absorber may be, for example, 2-(5-Methyl-2-hydroxyphenyl)benzotriazole, 2-(2-Hydroxy-3,5-bis(α,α-dimethylbenzyl)phenyl)-2H-benzotriazole, 2-(3-t-Butyl-5-methyl-2-hydroxyphenyl)-5-chlorobenzotriazole, and the like.

In addition, benzophenone series, phenyl salicylate series, hindered amine series, or the like, may be used as other light-resistant stabilizer, in combination with the aforementioned ultraviolet absorber.

Alternatively, the aforementioned ultraviolet absorber may be used in combination with the ultraviolet absorber with the maximum absorption wavelength of 300 nm or less.

It is preferable that the concentration of the ultraviolet absorber in the methacrylic resin is from 0.01 to 0.3 parts by mass as described above. Within this range, UV cutting effect being the original purpose of the ultraviolet absorber is very efficient, and also effectively prevents deterioration and whitening of the methacrylic resin, caused by converting the absorbed ultraviolet rays into the amount of heat. Particularly, the concentration of the ultraviolet absorber in the methacrylic resin is from 0.03 to 0.27 parts by mass is preferable, and the range from 0.05 to 0.25 parts by mass is much more preferable.

An optimum range of the absorption wavelength of the lens 3 is approximately from 320 to 380 nm.

By adjusting the content rate of the ultraviolet absorber to fall into the range as described above, the absorption wavelength range of the lens 3 may become around 340 to 360 nm, thereby achieving spectral transmittance of 10% to 15%.

In addition, it is necessary to adjust the color temperature of the lens 3 as required by the strobe light device. Dyes and pigments are widely usable as the color temperature adjuster, and there is no particular limitation. By way of example, examples of yellow color series may include; condensed azo compounds such as Cromophtal yellow, azo complex salts such as Benzimidazolone yellow, inorganic pigments such as yellow iron oxides, cadmium yellow, titan yellow, chrome yellow, and yellow lead, insoluble azo compounds such as Fast yellow, condensed polycyclic pigments such as Flavanthrone yellow, organic pigments such as Naphthol yellow and Pigment yellow, and the like.

In particular, Macrolex yellow, Cromophtal yellow, and the like, are preferable as the color temperature adjuster, since those colors have good dispersibility, excel in heat resistance and light resistance, and just a few amount thereof allows the adjustment of color temperature optionally without impairing other performance of the lens, such as transmittance and strength.

The maximum absorption wavelength of the color temperature adjuster falls into the range around 380 to 495 nm, and color agents with the spectral transmittance in the range from 5% to 30% are preferable. The range from 8% to 25% is more preferable. This range may generate a synergistic effect that it is possible to efficiently make use of the capabilities of the color temperature adjusting function, with just a small amount of color agent, and also reduce the amount of the ultraviolet absorber. Therefore, whitening phenomenon is effectively prevented, which is caused by converting UV rays absorbed by the ultraviolet absorber into an amount of heat.

The concentration of the color temperature adjuster in the methacrylic resin is, preferably, from 0.0001 to 0.0045 parts by mass, and more preferably, it is from 0.0001 to 0.004 parts by mass. Particularly, the range from 0.0005 to 0.002 parts by mass is much more preferable.

The aforementioned methacrylic resin, the ultraviolet absorber, and the color temperature adjuster are melted and kneaded and molded according to injection molding, extrusion molding, cast molding, or the like, thereby producing the lens 3. The lens 3 obtained in this way is placed on the aperture of the reflector 2 that has been produced separately by using a sheet metal die. In the actual assembling process, the reflector 2 is placed within a case not illustrated, the illuminator 1 is placed inside the reflector, and the lens 3 is fixed on the aperture of the case.

The lens for the strobe light device of the present embodiment may be applicable not only to the strobe light device, but also to any type of illuminating device, from a small size to a large size.

The strobe light device or an illuminating device large in size includes a large number of illuminators (light sources)₁. In particular, as for the device in which distance from the illuminator 1 to the lens 3 is short, being thin, internal temperature of the device is prone to increase, specifically when the distance from the illuminator 1 to the lens 3 is 50 mm or less. Therefore, the aforementioned lens 3 molded from methacrylic resin containing 0.01 to 0.3 parts by mass of ultraviolet absorber is effective for preventing deterioration and whitening due to the heat.

Particularly, as for a small-sized device such as the strobe light device of a camera, the output from the illuminator 1 is strong, the distance from the light source to lens 3 is extremely short such as around 3 to 5 mm, internal spacial capacity is small, and thus the temperature is prone to increase. Therefore, the lens 3 of the present embodiment is effective.

As shown in FIG. 3, light-diffusing fine particle (filler)) 4 may be added to the lens 3. By adding the filler 4, the light passing through the lens 3 is allowed to be diffused. The refractive index, particle size, and additive amount of the filler 4 may be set to appropriate values. With this configuration, while maintaining a predetermined light quantity and a predetermined orientation angle as the strobe light device, being achieved by the shape of the reflecting surface of the reflector 2 and the refractive index of the base material and the shape of the lens 3, it is possible to reduce local disorder of orientation characteristics, according to the light diffusion by the filler 4.

As the light diffusing particle (filler) 4, an inorganic fine particle such as alumina, titanium oxide, calcium carbonate, barium sulfate, silicon dioxide, a glass bead; an organic fine particle such as crosslinked styrene bead, crosslinked MS bead, and crosslinked siloxane based bead, or the like. It is further possible to use a crosslinked hollow particle composed of a resin material having high transparency, such as a methacrylic resin, polycarbonate based resin, MS resin, cyclic olefin based resin; and a hollow fine particle composed of glass, or the like.

In particular, a crosslinked organic particle is preferable as the filler 4. By the use of the crosslinked organic particle as the filler, it is possible to design a superior molding material with high optical transparency and high light diffuseness, having less unevenness in dispersing of light diffusing agent within the methacrylic resin that constitutes a matrix (base material). A particularly preferable crosslinked organic particle is an acrylic-based resin particle, styrene-based resin particle, and crosslinked silicone-based particle. A crosslinked copolymer particle of a monofunctional vinyl monomer, such as methyl methacrylate, and a polyfunctional vinyl monomer may be taken as an example of the acrylic-based particle. A crosslinked copolymer particle of a styrene monomer and a polyfunctional vinyl monomer may be taken as an example of the styrene-based resin particle, for instance.

It is to be noted that for the filler 4, any type of the fine particles described above may be used in isolation, or multiple types thereof may be used in combination, and there is no restriction for the usage.

The filler 4 to be used here has the range of refractive index between or equal to 1.3 to 2.8. In particular, the range between or equal to 1.3 to 2.0 is preferable, and the range between or equal to 1.3 to 1.7 is more preferable. This range above is preferable because if the refractive index is lower than 1.3, scattering becomes too weak to contribute to “image quality enhancement”. On the other hand, if the refractive index exceeds 1.7, scattering becomes too strong, and the light may go outside of a required field angle. This may easily cause a reduction of light quantity and lowering of light distribution angle, resulting in an unfavorable situation.

It is to be noted here that the refractive index referred to here is a value obtained by the measurement carried out by using D-line (589 nm) at the temperature of 20° C. There is an example of method for measuring the refractive index of the filler (fine particle) 4 as the following; fine particles are immersed in the liquid whose refractive index is allowed to vary gradually, and interfaces between the fine particles and the liquid are observed while varying the refractive index of the liquid. Then, the refractive index of the liquid is measured when the interfaces between the fine particles and the liquid become unclear, and this is assumed as the refractive index of the fine particle. Abbe refractometer, or the like, may be employed for measuring the refractive index of the liquid.

The filler 4 to be used here has a mean particle size between or equal to 0.1 μm to 20 μm. In particular, the range between or equal to 0.3 μm to 15 μm is preferable, and the range between or equal to 0.5 to 10 μm is more preferable. The range between or equal to 1.0 μm to 7.0 μm is much more preferable. The range above is preferable because if the mean particle size is equal to or lower than 20 μm, it is possible to allow the outgoing light to diffuse, achieving a target diffusion property necessary for the stroboscopic light emitting device. If the mean particle size is equal to or higher than 0.1 μm, light loss toward the rear side (the illuminator 1 side) due to the reflection, or the like, can be suppressed, thereby allowing the incident light to diffuse efficiently toward a luminous surface side (photographic subject side). Therefore, it becomes possible to obtain a target light quantity for the strobe light device.

The additive amount (blending quantity) of the filler 4 to the base material (transparent thermoplastic resin) is set to between or equal to 0.1 parts by mass to 3.0 parts by mass, to 100 parts by mass of the base material (transparent thermoplastic resin). In particular, the range between or equal to 0.3 parts by mass to 2.0 parts by mass is preferable, and the range between or equal to 0.5 parts by mass to 1.5 parts by mass is more preferable. The range between or equal to 0.5 parts by mass to 1.0 parts by mass is much more preferable. The range above is preferable because if the additive amount is equal to or smaller than 3.0 parts by mass, it is possible to obtain a predetermined light quantity and orientation necessary for the strobe light device. If the additive amount is set to be equal to or larger than 0.1 parts by mass, the development of the light diffusion effect of the filler 4 can be achieved, thereby contributing to the enhancement of the image quality.

Preferably, the transmission factor of the lens 3, after the filler 4 is added and the lens 3 is molded, falls into the range between or equal to 80% to 95%. If the transmission factor is lower than 80%, the light diffuseness becomes so strong that the light quantity for the strobe apparatus goes down. If the transmission factor exceeds 95%, there is too much transmission light, causing deterioration of the light diffusing effect. Variation of the additive amount of the filler 4 may control the transmission factor of the lens. It is to be noted that the transmission factor can be measured by measuring a total light transmission factor, for instance. According to the method defined in JIS K 7105 “Testing methods for optical properties of plastics”, a resin sheet is cut out in a sample size of 50×50 mm, and subsequently, a turbidimeter (model No. 1001DP, a product of Nippon Denshoku Industries Co., Ltd.) is used to measure the total light transmission.

Here, a method for producing the lens 3 will be explained in the case where the filler 4 is added. Firstly, the filler 4 is homogeneously dispersed in the base material. A publicly known method may be employed as the dispersion method. By way of example, it is preferable that after mixing by a drum blender or a Henschel mixer, the materials are melted and kneaded by a vent-type uniaxial or biaxial extruder at the temperature from 220° C. to 250° C., and then a pellet is obtained. Thereafter, the pellet is molded by an injection molding machine, at the resin temperature from 240° C. to 250° C., and then, the lens 3 is obtained.

Next, the operation of each element in the strobe light device to which the filler 4 is added as shown in FIG. 3, will be explained.

The light outputting from the illuminator 1 goes to the aperture 2b, directly or reflected by the reflector 2, and enters the lens 3. The outgoing light that expands outwardly from the aperture 2b is refracted to the optical axis 5 direction by the lens 3. With this operation, the light quantity illuminated on the photographic subject is increased, thereby achieving a predetermined light quantity and orientation characteristics. In this situation, since bends 2a are provided on the reflector 2, a reflecting angle at each bend 2a varies in a discontinuous manner. Therefore, as shown in FIG. 3, in the light entering the lens 3 directly from the illuminator 1 or reflected by the reflector 2, there are developed a light beam concentrated part where the reflected light beams overlap one on another, and a light beam sparse part where the reflected light beams do not overlap. Since the refractive index, the particle size, and the additive amount of the filler 4 are appropriately configured and the light is diffused adequately, the sparse or dense condition of the incident light beams is improved, and this may restrain local disorder of the orientation characteristics. Here, it is to be noted that the operations of the ultraviolet absorber and the color temperature adjuster contained in the lens 3 occur in the same manner as the case where the filler 4 is not added to the lens 3, and therefore it is possible to prevent whitening and adjust the color temperature.

### EXAMPLES

Hereinafter, the present invention will be specifically explained according to the following examples, but the present invention is not limited to those examples.

### Example 1

In the example 1, the lens 3 was produced using the following materials. As the methacrylic resin, “Delpet 80N” (a product of Asahi Kasei Chemicals Corporation) was used, and as the ultraviolet absorber, 2-(3-t-butyl-5-methyl-2-hydroxyphenyl)-5-chlorobenzotriazole (a product of Shipro Kasei Kaisha, Ltd., Trade name: Seesorb 703) was used, setting the additive amount of the ultraviolet absorber to 0.2 parts by mass. Then, the materials were melted and kneaded using a biaxial extruder, and a pellet was obtained. The color temperature adjuster was not added.

Plates being 50 mm×90 mm in size, and respectively, 1 mm, 2 mm, and 3 mm in thickness, were molded from this pellet by an injection molding machine, and test pieces of the lens 3 were produced.

### Comparative Examples 1 to 3

As the comparative examples 1, 2, and 3, plates were molded by kneading the ultraviolet absorber, setting the additive amount thereof to 0.35, 0.4, and 0.5 parts by mass, respectively, and the other conditions were configured to be the same as the example 1.

### (Evaluations of Example 1 and Comparative Examples 1 to 3)

The test pieces of the embodiment 1, and the comparative examples 1 to 3 were evaluated as to the color temperature, yellowing of lens, and whitening phenomenon, using the xenon lamp at the color temperature of 6360K as the illuminator 1. The distance between the illuminator 1 and the lens was 1,000 mm. A method for evaluation was as the following.

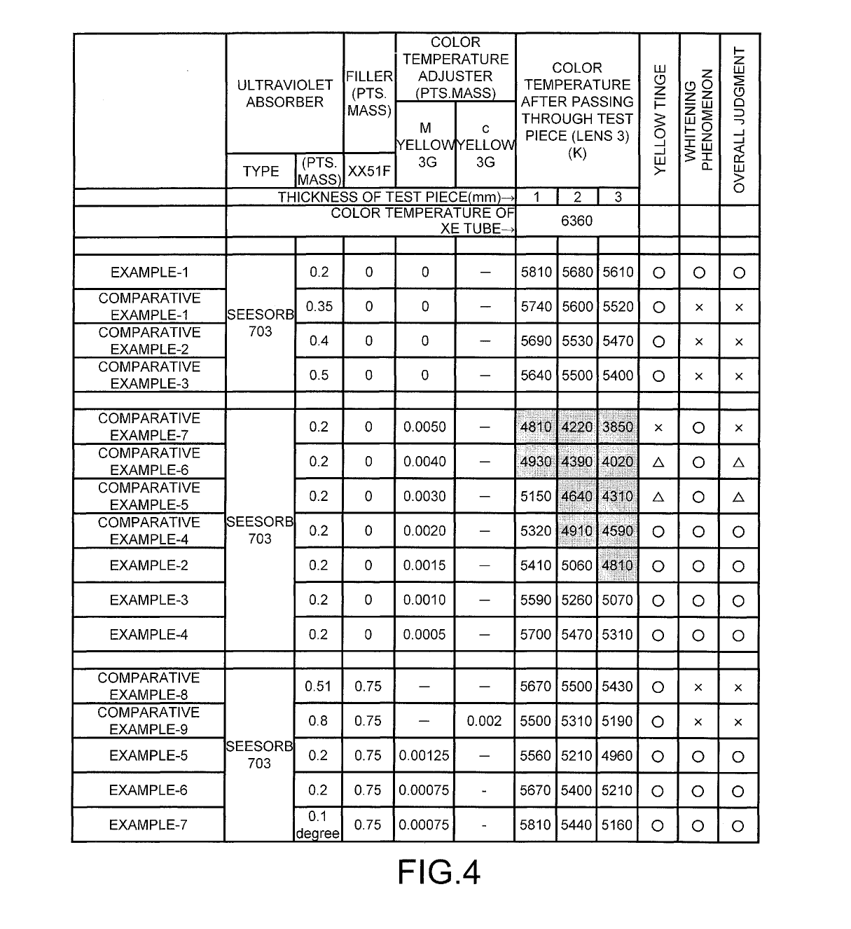

FIG. 4 shows the evaluation result.

### (Evaluation Method)

### 1) Measure the Color Temperature

Measurement of the color temperature was performed using the color meter IIIF, a product of Minolta Corporation.

### 2) Observe the Appearance (Yellow Tinge) of the Lens

The appearance of the lens was visually observed. If the appearance showed transparency without yellow tinge, the evaluation result was marked with “Circle”. If the appearance is yellowish to some extent, but it is permissible depending on the lens plate thickness, the evaluation result was marked with “Triangle”. If yellow tinge was visible on appearance and it is impermissible as the appearance of the strobe light device, the evaluation result was marked with “X”.

### 3) Continuous Flash Firing Test of the Strobe Light

Flash of the strobe light device being produced was fired 5,000 times continuously, and thereafter it was visually observed whether or not whitening occurred in the lens. If whitening was invisible, the evaluation result was marked with “Circle”, whereas if whitening was visible, the evaluation result was marked with “X”.

As shown in FIG. 4, neither yellow tinge nor whitening phenomenon occurred in the test piece of the example 1. In addition, the light of the xenon lamp at the color temperature of 6360K passed through the test piece (the lens 3), thereby adjusting the temperature to the range from 5000K to 6000K being preferable as the strobe light device. In contrast, the whitening phenomenon occurred in all of the comparative examples 1 to 3.

### Examples 2 to 4

In the examples 2 to 4, similar to the example 1, “Delpet 80N” was used as the methacrylic resin, and as the ultraviolet absorber, 2-(3-t-butyl-5-methyl-2-hydroxyphenyl)-5-chlorobenzotriazole (a product of Shipro Kasei Kaisha, Ltd., Trade name: Seesorb 703) was used, setting the additive amount of the ultraviolet absorber to 0.2 parts by mass. Moreover, as the color temperature adjuster, Macrolex yellow 3G (a product of Bayer AG, the maximum absorption wavelength is 400 nm); 0.0015, 0.0010, and 0.0005 parts by mass, was added to 100 parts by mass of the base material. Test pieces being 1 mm, 2 mm, and 3 mm in thickness were produced, setting the other conditions to be the same as the example 1.

### Comparative Examples 4 to 7

As the comparative examples 4 to 7, the additive amount of the color temperature adjuster was varied to 0.0020, 0.0030, 0.0040, and 0.0050 parts by mass, respectively, and test pieces were molded setting the other conditions to be the same as the examples 2 to 4.

### (Evaluations of Examples 2 to 4 and Comparative Examples 4 to 7)

According to the evaluation method similar to the example 1, the color temperature, yellow tinge of the lens, and whitening phenomenon were evaluated.

As shown in FIG. 4, neither yellow tinge nor whitening phenomenon occurred in any of test pieces of the examples 2 to 4. As for the color temperature, as shown in FIG. 4, the color temperature after passing through the test piece of the example 2 being 3 mm in thickness, was lower than 5000K, but other test pieces were successfully adjusted to the range from 5000K to 6000K being preferable as the strobe light device.

In contrast, as shown in FIG. 4, no whitening phenomenon in any of the test pieces of the comparative examples 4 to 7, but the evaluation result regarding the yellow tinge of the test pieces of the comparative examples 5 to 7 were marked with “Triangle” or “X”. Also with regard to the color temperature of the test pieces in the comparative examples 6 and 7, the color temperature after passing through the test pieces of any thickness, was not able to be adjusted to the range from 5000K to 6000K that is preferable as the strobe light device.

### Examples 5 to 7

In the examples 5 to 7, similar to the example 1, “Delpet 80N” was used as the methacrylic resin, and as the ultraviolet absorber, 2-(3-t-butyl-5-methyl-2-hydroxyphenyl)-5-chlorobenzotriazole (a product of Shipro Kasei Kaisha, Ltd., Trade name: Seesorb 703) was used. As shown in FIG. 4, the additive amount of the ultraviolet absorber was set to 0.2 parts by mass in the examples 5 and 6, and around 0.1 parts by mass in the example 7. Moreover, as the color temperature adjuster, Macrolex yellow 3G (a product of Bayer AG) was added, 0.00125 parts by mass in the example 5, and 0.00075 parts by mass in each of the examples 6 and 7, to 100 parts by mass of the base material. Furthermore, crosslinked MS based particles (a product of Sekisui Plastics Co. Ltd., XX51F) approximately 5 μm in the mean particle size were added as the filler 4. The additive amount of the filler 4 was 0.75 parts by mass to 100 parts by mass of the base material, in any of the examples 5 to 7. Test pieces being 1 mm, 2 mm, and 3 mm in thickness were produced, setting the other conditions to be the same as the example 1.

### Comparative Examples 8 and 9

As the comparative example 8, 0.51 parts by mass of the ultraviolet absorber was added, the filler similar to the examples 5 to 7 was added, without adding the color temperature adjuster, and test pieces were molded setting the other conditions to be the same as the examples 5 to 7.

As the comparative example 9, 0.8 parts by mass of the ultraviolet absorber, and as the color temperature adjuster, 0.002 parts by mass of Cromophtal yellow 3G (a product of Bayer AG, the maximum absorption wavelength is 400 nm) were added, and the filler similar to the examples 5 to 7 was also added. Then, test pieces were produced setting the other conditions to be the same as the examples 5 to 7.

### (Evaluations of the Examples 5 to 7 and Comparative Examples 8 and 9)

According to the evaluation method similar to the example 1, the color temperature, yellow tinge of the lens, and whitening phenomenon were evaluated.

As shown in FIG. 4, neither yellow tinge nor whitening phenomenon occurred in any of the test pieces of the examples 5 to 7. The color temperature after passing through the test piece was adjusted to the range from 5000K to 6000K being preferable as the strobe light device. In other words, it was verified that addition of the filler 4 had no impact on the prevention of the whitening phenomenon and suppression of yellow tinge, nor on the operation for adjusting the color temperature.

In contrast, in the test pieces of the comparative examples 8 and 9, as shown in FIG. 4, whitening phenomenon occurred in all of the test pieces, since the additive amount of the ultraviolet absorber was large.

### INDUSTRIAL APPLICABILITY

The lens of the present invention is suitable for the strobe light device, but this is not the only usage. It is industrially applicable to other low-profile illumination devices in which the distance between the light source to the lens is short, such as an irradiation device used for a portable terminal, back light of a liquid crystal display, LED illumination, LED liquid crystal unit, a traffic destination board on a road, a destination board at a station, and an advertising display, for instance.

### EXPLANATION OF REFERENCES

1 . . . illuminator, 2 . . . reflector (reflection element), 2a . . . bend, 2b . . . aperture, 3 . . . lens, 4 . . . filler

1. A strobe light device comprising an illuminator, and a lens allowing light emitted from the illuminator to pass through and illuminate the light outwardly, wherein:
the lens comprises a base material and an ultraviolet absorber,
the base material is methacrylic resin, and
the ultraviolet absorber is contained in a range of 0.01 to 0.3 parts by mass to 100 parts by mass of the base material, inclusive.

2. The strobe light device according to claim 1, wherein the lens further comprises a visible light absorber as a color temperature adjuster, and the visible light absorber has a maximum absorption wavelength in a range of 380 to 495 nm, inclusive.

3. The strobe light device according to claim 2, wherein the visible light absorber is contained in a range of 0.0001 to 0.0045 parts by mass to 100 parts by mass of the base material, inclusive.

4. The strobe light device according to claim 2, wherein the visible light absorber is contained in a range of 0.0001 to 0.004 parts by mass to 100 parts by mass of the base material, inclusive.

5. The strobe light device according to claim 2, wherein the visible light absorber is contained in a range of 0.0005 to 0.002 parts by mass to 100 parts by mass of the base material, inclusive.

6. The strobe light device according to claim 1, wherein the ultraviolet absorber has a maximum absorption wavelength in a range of 300 to 400 nm, inclusive.

7. The strobe light device according to claim 1, wherein the methacrylic resin comprises at least 50 weight % of methyl methacrylate.

8. The strobe light device according to claim 1, wherein the ultraviolet absorber is a benzotriazole type, having a maximum absorption wavelength in a range of 300 to 400 nm, inclusive.

9. The strobe light device according to claim 1, wherein the lens further comprises a filler, and wherein:
a refractive index of the filler is in a range of 1.3 to 2.8, inclusive,
an average particle size of the filler is in a range of 0.1 to 20 μm, inclusive, and
a content rate of the filler is in a range of 0.1 to 0.3 parts by mass to 100 parts by mass of the base material, inclusive.

10. The strobe light device according to claim 9, further comprising a reflector configured to reflect the light from the illuminator toward the lens, wherein the reflector takes a form that is made by bending a planar member.

11. The strobe light device according to claim 9, wherein the filler is a crosslinked organic particle.

12. The strobe light device according to claim 1, wherein the illuminator comprises at least either one of a xenon lamp and a semiconductor light emitting element.
